(19) United States
(12) Patent Application Publication
(10) Pub. No.: US 2012/0248176 A1
(43) Pub. Date: Oct. 4, 2012

(54) SOLDER PASTES FOR PROVIDING IMPACT RESISTANT, MECHANICALLY STABLE SOLDER JOINTS

(76) Inventors: DERRICK Matthew HERRON, Canastota, NY (US); NING-CHENG LEE, New Hartford, NY (US); FENGYING ZHOU, JiangSu (CN)

(21) Appl. No.: 13/078,824

(22) Filed: Apr. 1, 2011

(51) Int. Cl. B23K 1/20; B23K 35/24; B23K 35/363

(52) U.S. Cl. 228/248.1; 148/24

(57) ABSTRACT

A solder is provided that produces a more impact resistant solder joint that is usable in high-end applications. The solder joint has a strong interconnection that can perform all of the normal functions of a solder joint while being more impact resistant. Furthermore, the solder joint retains its capabilities over the service life of a high-end product such as a computer or a cell phone. The solder meets the requirements of the soldering industry both today and into the future, including but not limited to an ability to be printed or dispensed with standard methods and conformity to health and safety standards.

### TECHNICAL FIELD

The present invention relates generally to solder materials, and more particularly, some embodiments relate to solder pastes comprises a flux, solder powder, and high melting temperature filler particles providing impact resistant solder joints.

### DESCRIPTION OF THE RELATED ART

For centuries solder has been used as a way of joining things together, both mechanically and electrically. Solders can be composed of many different metals, including but not limited to tin, silver, copper, lead, bismuth, zinc, germanium, and indium.

In today's developed societies, mobile devices, such as phones, personal digital assistants, or portable computers are ubiquitous. As devices become more mobile, there is a much higher chance that they will be dropped, bumped, or otherwise impacted in some way. The circuitry inside these devices is held together with solder and, therefore, the solder must be able to stand up to these impacts without failing over the entire service life of the product.

To apply solder to a circuit board, typically a solder paste is used. The paste is generally comprised of a flux mixed with a powdered solder alloy. The flux would be selected based on the need to be cleaned after reflow, need to be halogen-free, and oxidation cleaning ability among other features. Solder powder would be selected based on required reflow temperature, service temperature of the device, and particle size requirements, among other features. With all of these considerations taken into effect, a proper paste would be made by mixing the powder into the flux at a desired metal load. The paste would he either dispensed or printed through the apertures of a stencil onto the circuit board, components would be placed on top, and the board would be reflowed to make solid solder joints after cooling.

Due to the solid and somewhat fragile nature of the tin-based lead-free solder joints, various attempts have been made throughout the years to make the solder joints better able to stand up to the impacts imposed on them by a mobile society. Some of these attempts have focused on the addition of high-melting temperature filler particles to form a composite solder joint.

In one example, a filler material consisting of a copper core electrolessly coated with a thin layer of tin was investigated. The solder, when reflowed, reacts with the metals of the component pads as well as with the filler particles to form intermetallics. Particularly in this case, the solder reacts completely until the entire joint is thin and composed of intermetallic compounds. This is only a good choice in very specific applications (for example bonding a die to die and then encapsulating in polymer) and not in standard surface mount technology uses. Having a joint entirely comprised of intermetallic compounds would make it very brittle and a very impact susceptible interconnection.

In another example, a solder consisting of a tin-silver alloy with filler particles of tin, silver, nickel, copper, or bismuth ranging in size from 30-100 microns was investigated. The sizes of these particles are very limiting in today's miniaturized world. Standard Type 3 (45-25 micron) and Type 4 (38-20 micron) solder powders fall into the low end of this range or below, with forward-looking Type 5 (25-15 micron) and Type 6 (15-5 micron) powders being even smaller. Solder paste for mobile and high-end applications needs to be very precisely printed through a stencil with small apertures or dispensed through a needle, both of which would become clogged in many current applications when powder of this size was used. Furthermore, these large filler particle sizes could lead to high volume inter metallic deposits within the solder joint, causing it to become quite brittle over its service life, especially in a high-end product. Therefore, this solder would be limited to low-end applications and not today's popular mobile devices.

### BRIEF SUMMARY OF EMBODIMENTS OF THE INVENTION

According to various embodiments of the invention, a solder is provided that produces a more impact resistant solder joint that is usable in high-end applications. The solder joint has a strong interconnection that can perform all of the normal functions of a solder joint while being more impact resistant. Furthermore, the solder joint retains its capabilities over the service life of a high-end product such as a computer or a cell phone. The solder meets the requirements of the soldering industry both today and into the future, including but not limited to an ability to be printed or dispensed with standard methods and conformity to health and safety standards.

According to further embodiments of the invention, a new method of producing solder paste is described in which a high-melting temperature particle is mixed into the solder paste as a filler particle. In one exemplary embodiment the invention can be described as an improved solder paste that produces a solder joint that is both electrically connective and strong while also being more impact resistant than a typical solder joint, especially useful for high-end mobile devices. The solder paste is designed to meet the criteria needed for a solder paste while increasing the impact resistance of the reflowed solder joint. The solder paste can be described as a flux mixed with a solder powder and a lower volume fraction of high-melting temperature filler particles with a wettable surface.

In a further embodiment, the filler particles can be pretreated chemically prior to use which can protect them from oxidation and/or reaction with the flux, help the solderability to the filler material, and improve the finished solder joint.

In further embodiments, the high-melting temperature filler particles have a solderable surface and a core material that is nonreactive with the metals of the surrounding solder over time to make the joint stable over its service life.

In still further embodiments, during reflow at temperatures higher than the melting temperature of the solder powder but below that of the filler materials, the solder will wet to the surfaces of the filler particles and they will be distributed throughout the solder joint, being present both at the IMC interface and through the bulk of the solder.

In additional embodiments, the solder wets to the pads on the surface of components and/or circuit boards. The high melting temperature particles remaining in the joint will act to inhibit crack growth through the solder, forcing cracks to either terminate or change direction when encountering a filler particle, slowing propagation and complete breakage of the solder joint.

In further embodiments, filler particles with a nonreactive core in relation to the metals of the surrounding solder cause the solder joint to remain stable over time without excessive brittle intermetallic formation throughout the joint. Filler particles remain in their post-reflowed state over the service life of the product, continuing to inhibit crack growth through the solder.

A solder paste, comprising a flux; a solder powder; and a metal filler powder, the metal filler powder comprising metal filler particles having melting temperatures greater than a melting temperature of the solder of the solder power, and the metal filler particles having surfaces that are wettable to the solder of the solder powder; wherein the ratio of the metal filler powder to the total of the metal filler powder and solder powder is such that, after forming a solder joint under reflow soldering at a temperature below the melting temperature of the metal filler particles, a continuous ductile phase of the solder is present in the solder joint and the metal filler particles are present at an inter metallic interface

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a metal filler particle that may be utilized in metal filler powders implemented in accordance with an embodiment of the invention.

FIG. 2 illustrates an assembly with solder paste implemented in accordance with an embodiment of the invention.

FIG. 3 illustrates a solder joint after reflow, in accordance with an embodiment of the invention.

FIG. 4 illustrates crack formation in a solder joint formed in accordance with an embodiment of the invention.

The figures are not intended to be exhaustive or to limit he invention to the precise form disclosed. It should be understood that the invention can be practiced with modification and alteration, and that the invention be limited only by the claims and the equivalents thereof,

### DETAILED DESCRIPTION OF THE EMBODIMENTS OF THE INVENTION

The present invention is directed toward a solder paste and mechanically stable solder joints having improved impact resistance. The solder paste comprises a solder power, a metal filler powder, and a flux. The metal filler powder comprises high-melting temperature filler particles with a surface solderable to the solder of the solder powder. When a solder joint is impacted due to the dropping of the device or by some other force, cracks will begin to form in the solder. The inclusion of the filler particles will stop or alter the direction of these cracks by having some of the non-brittle filler particles sitting in the brittle IMC layer where the crack normally propagating through, leading to much longer reliability before the joint completely breaks and fails.

In some embodiments, the solders will be employed in inexpensive products or products with short service lives, such as a child's toy. In these embodiments, the solder joint does not need to live up to a prolonged service life. High melting temperature filler particles that can continue to react with the metals of the surrounding solder over time, causing more intermetallic growth and leading to increased brittleness, may be used in these embodiments because of the short required service life.

In other embodiments, the application may be for products where a longer service life is desired, such as mobile phones. In these embodiments, the Filler particles comprises high melting temperature filler particles with a non-reactive core material. The non-reactive core is left interspersed throughout the solder joint, both at the IMC interface and through the bulk of the solder and remains stable over the service life of the product, thus producing a very stable and impact resistant solder joint.

In some embodiments, high melting temperature particles with a solderable surface were added to solder paste in volumes that allow the continuous phase of the reflowed solder to remain ductile. The solder paste was reflowed at a temperature below that of the melting temperature of the filler particles and the resulting solder joint has the particles distributed throughout its bulk. When impacted, crack propagation across the solder joint is stopped or inhibited by the presence of the particles.

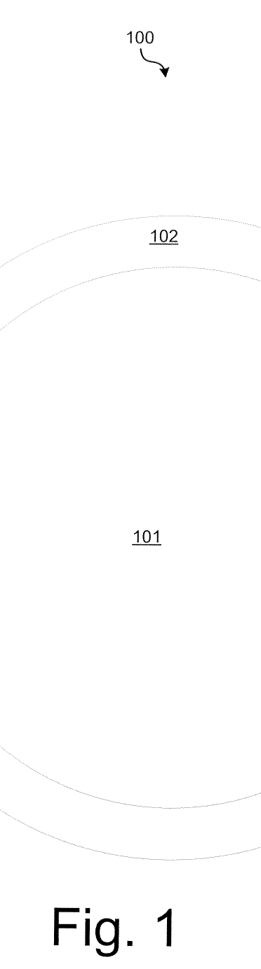

FIG. 1 illustrates a metal filler particle that may be utilized in metal filler powders implemented in accordance with an embodiment of the invention. The metal filler particle 100 comprises a main body 101 of a metal having a melting temperature significantly higher than that of the solder employed in the solder powder of the solder paste. In some embodiments, the metal filler particles comprise chromium, cobalt, copper, iron, manganese, nickel, or zinc particles. In further embodiment, the metal filler particles may comprise titanium, vanadium, molybdenum, tungsten, Monel alloy (an alloy of Ni, Cu, Fe, and Mn), Nichrome (a nickel chromium alloy), Invar (a nickel iron alloy), or bronze (a copper tin alloy). In a particular embodiment, temperature constraints are defined so that the high-melting temperature particle has a melting point at least 25 degrees C. above that of the reflow temperature of the solder for the application on which it is being used to ensure that it is not melted during the process.

After reflow of the solder paste, at a temperature below the melting temperature of the main body 101, the resultant joint comprises a ductile continuous volume of solder embedded with the particles 100. In some cases, some of the metal of body 101 may react with or be absorbed by the solder of the solder paste. However, the particles 100 remain as long as this reaction or absorption is not complete, and some volume of the metal of body 101 remains after reflow. Accordingly, in a particular embodiment, the lower size of the metal filler particles 100 is configured according to the particular metal used in the body 101 and the composition of the solder of the solder powder. In experiments, metal filler particle sizes of approximately 9 μm remained present in the solder joint after reflow, with the initial sizes for the metal filler particles being about 9 to 10 μm.

In some embodiments, the main body 101 comprises a metal that does not react with the solder of the solder powder to form intermetallic compounds, or reacts very slowly with the solder. In these embodiments, after reflow, the metal particles 100 remain present in the solder joint after reflow. Furthermore, since the bodies 101 do not react, or react slowly with the solder, the particles 100 remain present in the joint throughout the average service life of the component being soldered, for example, the average service life may comprise manufacturer's predicted or desired service life. For example, in an embodiment employing a tin-silver or tin-silver-copper solder, the particles 100 may comprise a main body 101 of iron.

In other embodiments, the main body 101 comprises a metal that has a higher melting temperature than the solder, but that does react with the solder. In these embodiments, during reflow at a temperature below the melting temperature of the body 101, the metal particles 100 still remain present in the solder joint after reflow. However, because the body 101 will react with the solder, it may eventually be consumed as an intermetallic with the solder during the lifetime of the device. For example, in an embodiment employing a tin-silver or tin-silver-copper solder, the particles 100 may comprise a main body 101 of copper.

In some embodiments, the metal filler particle 100 further comprises a coating of a solderable material 102. The coating 102 is wetted by the solder of the solder powder during the reflow process. In further embodiments, the coating 102 has a thickness sufficient to allow the solder to wet to the coating. In some embodiments, the coating materials comprise metals that are capable of forming a thin layer 102 on the surface of the chosen core material 101. In particular embodiments, the coating 102 has a minimum thickness that still allows the solder to wet to the coating, such as 0.1-0.2 μm. In some embodiments, the wettability assists the particle to remain embedded in the solder joint without expulsion. In some embodiments, the coating 102 comprises copper, silver, solder, tin, nickel, gold, palladium, or platinum. In further embodiments, the coating 102 comprises titanium, vanadium, molybdenum, tungsten, Monel alloy, Nichrome. Invar, or bronze (a copper tin alloy). In particular embodiments, copper is utilized as a coating, for example, to form copper coated iron metal filler particles. In other particular embodiments, silver or nickel is used as a coating, for example to form silver coated nickel particles, or nickel coated copper particles. In still further embodiments, the filler particles 100 may be chemically treated with an oxidation prevention treatment. For example, the filler particles 100 may be treated in a manner similar to those employed on solder pads, such as OSP (organic solderability preservatives) or HASL (hot air solder leveling). In some embodiments, these treatments prevent oxide formation in the solder paste prior to use and may prevent reactions between the flux and the particles 100. The chemical treatment may further improve the distribution of the particles through the joint caused by better wetting. In some embodiments, the metal filler particles 100 may be provided with the coating 102 through various treatments, for example, an oxidation reduction reaction may be used to form copper coated iron metal filler particles.

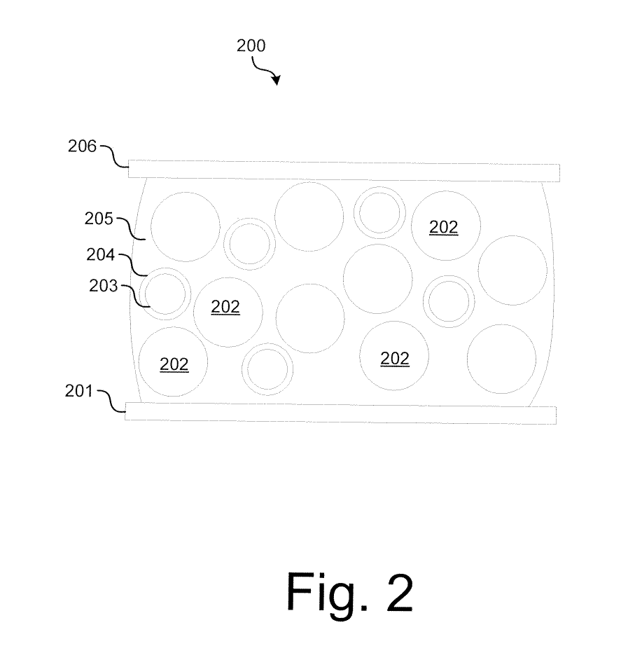

FIG. 2 illustrates an assembly with solder paste implemented in accordance with an embodiment of the invention. The sizes and numbers of solder 202 and filler particles 203 are exaggerated for clarity. In the illustrated embodiment, the assembly 200 comprises a first component 201. For example, the component 201 may comprise a PCB board with a solder paste printed or dispensed onto the pad on the hoard. In some embodiments, the filler particle size is limited only by the size of the solder powder, most notably the same size as the solder particles or smaller so as not to clog dispensing needles or fine stencil apertures. For example, in some embodiments, the particle size for the solder powder and metal filler particles may be sufficiently small to be utilized in Standard Type 3 (45-25 micron), Type 4 (38-20 micron), Type 5 (25-15 micron), or Type 6 (15-5 micron) solder powder applications. Particularly, solder paste for mobile and high-end applications needs to be very precisely printed through a stencil with small apertures or dispensed through a needle. In some embodiments, the stencil sized used may impact the useable sizes of the metal filler particles. However, typically the metal filler particle sizes are less dependent on the stencil size than the solder particle sizes. Particularly, when the metal filler powder is between 0.5 wt. % and 5.0 wt. % of the solder paste, the metal filler particle sizes may be larger than the solder particles without clogging the stencil used. For example, in some embodiments, the metal filler particles may up to five, four, three, or two times the size of the solder powder. For example, in one embodiment, the solder particles are less than 30 μm, and the metal filler particles are less than 150, 120, 90, 60, or 30 μm

In some embodiments, in order for portable devices to be small and transportable, electronic components and, thus, solder joints are also required to be very small. Fine pitch design of circuit boards requires precision deposition of solder paste. The paste must be homogeneous and creamy so as to be deposited well. Since a flux mixed only with a solder powder works to form a usable solder paste, filler particles with sizes equal to or less than the size of the solder particles may be employed.

The assembly 200 further comprises the solder paste, comprising a flux 205, solder particles 202 and metal filler particles 203. The flux will clean the surfaces of the components 201 and 206 and the surfaces of the particles 203, and the solder will wet to the filler particles 203, producing a solder joint that, after cooling, is solid with filler particles 203 distributed throughout. The solder flux can be any standard solder flux 205 typically used for making solder paste. In some embodiments, the flux 205 is non-corrosive to the solder joint and should not be harmful to the chosen surface of the filler particles, for example, the flux may comprise a halide-free flux. In other embodiments, use of chemical treatment can mitigate the corrosion of the flux to the metal filler particles 203. Activators, rheological additives, tackifiers, solvents, perfumes and dyes can all be added to the flux as long as the above conditions are met.

In various embodiments, the solder powder 202 employed is defined by standard solder powder used in industry. Due to health and safety standards, typical solder powders may be lead free. For example, lead free alloys, such as tin-silver, or tin-silver copper solders, such as Sn96.5Ag3.5, Sn96.5Ag3.0Cu0.5, Sn98.5Ag1.0Cu0.5 may be employed. In other embodiments, lead-containing solders may be employed as needed by the user. When the solder powder 202 is mixed with the high-melting temperature filler particles 203 with a solderable surface 204 and then a flux 205 is mixed in, a solder paste is formed. When heated at reflow temperatures, the solder particles will melt and flow.

In some embodiments, the filler material (including filler particles 203 and coatings 204) is added in a volume percent of the total metal load (of the solder particles 202 plus the metal filler particles 203) limited only by a volume in which the reflowed solder remains a continuous ductile phase. In particular embodiments, this may be achieved with between 0.5% and 2.9% by weight of metal filler particles 203. Impact resistance may be affected by the specific weight percentages of specific metal filler particles. For example, zinc metal filler particles may show beneficial results between about 0.5 wt. % and 1.6 wt. %, particularly at around 1.2 wt. %; chromium metal filler particles may show beneficial results between about 0.8 wt. % and 1.5 wt. %, particularly at around 1 wt. %, and copper coating iron may show beneficial results from between about 1.5 wt. % and 5 wt. %, particularly at 2.3 wt. %. Accordingly, with a continuous ductile phase, the reflowed solder provides a solder joint that is solid with the filler particles distributed throughout the bulk of the material.

In the illustrated embodiment, the solder paste (203, 205, and 202) is dispensed through a needle or printed through a stencil onto a circuit board 201 as needed or desired. Components 206 are then aligned properly and placed onto the paste. The assembly is then reflowed to a temperature at which the solder 202 melts but the filler particles 203 do not, causing the solder 202 to flow and wet to the pads on the board 201 and component 206 as well as to the filler particles 203. The assembly is then cooled and the solder hardened, forming a solid solder joint between the pads on the board and component with the filler particles distributed throughout.

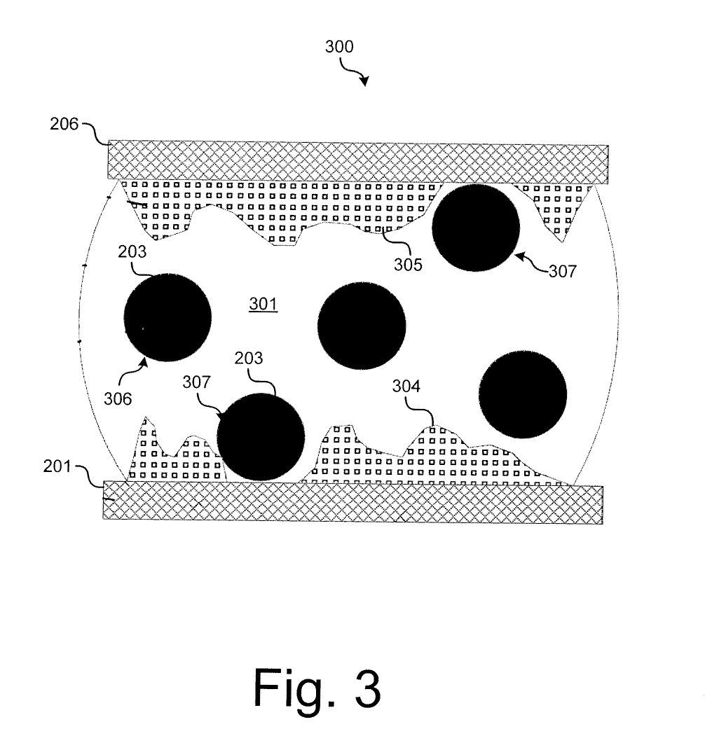

FIG. 3 illustrates a solder joint after reflow, in accordance with an embodiment of the invention. In the illustrated solder joint 300. The solder particles 202 have melted and coalesced into a solid solder matrix 301. The solid solder 301 is continuous throughout the joint 300. The cores of the filler particles 203 remain behind within the bulk 301 of the solder joint. With adequate wetting, a thin layer of intermetallic compound 305 or 304 forms between the solder 301 and the metal of the pads of components 201 or 206. Some filler particles 203 are located 306 within the bulk of the solder 301, while others are located 307 at the interface 305 or 304 between the bulk solder and the component 206 or 201, respectively. The thin, wettable surfaces of the filler particles are also consumed by the solder 301 to form a thin layer of intermetallic between the solder 301 and the body of the filler particle 203. If the filler particles 203 have a reactive core material, the intermetallic layer around them will continue to grow as heat and current are passed through the solder joint during its service life. Eventually the entire particle can be consumed into the surrounding solder and a large intermetallic area would be left behind. Although this would lead to an increased brittleness in the solder joint, such metal filler particles may be employed in low-end products, or products with short service lives. For high-end products or products where long service life is desired, an unreactive body of the filler particle 203 limits the amount the intermetalics coatings will grow during the service life.

In the illustrated embodiment, both with reactive or unreactive particles 203, thin intermetallic layers 305 and 304 are formed between the solder 301 and the metal of the pads 201 and 206 and the wettable surfaces of the filler particles 203. The intermetallics are brittle and in a standard solder joint would act as a continuous surface through which a crack could propagate across a solder joint, easily leading to failure. Embodiments of the invention reduce or eliminate this problem. Filler particles 203 near 307 the interface act to interfere with intermetallic formation, causing it to be discontinuous and therefore not a straight, brittle path for cracks to easily spread across. The particles 203 also act as barriers, forcing cracks to change direction when they come into contact with a filler particle 203.

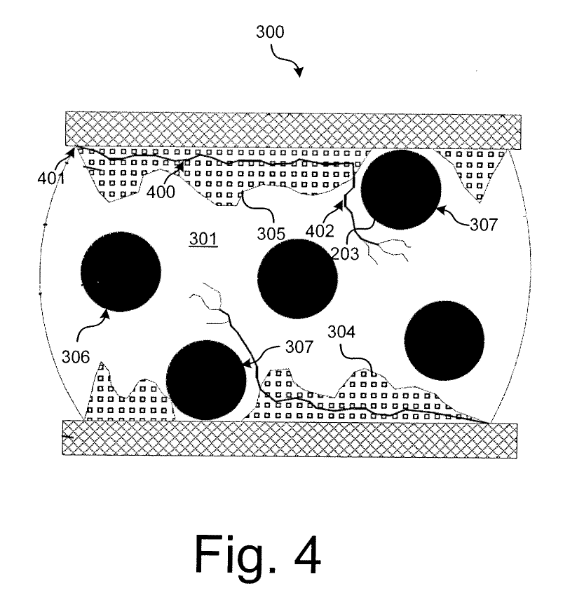

FIG. 4 illustrates crack formation in a solder joint formed in accordance with an embodiment of the invention. The illustrated solder joint 300 is formed in accordance with the method described with respect to FIGS. 2 and 3. The illustrated crack 400 has propagated from the intermetallic interface 305 into the solder matrix 301. Initially, an impact on the device can cause the crack to begin to form. With more stress or impacts, the crack will grow. In this embodiment, the filler particles that remain in the joint will act as barriers, forcing the crack to stop or change direction as they progress, and be directed into the solder 301. This will increase the number of impacts required for complete crack propagation considerably. In the illustrated embodiment, as the crack formed at the interface 304 and began to grow 401 along the intermetallic layer 305. The crack 400 encountered a filler particle 203 located 307 near the layer 305. This caused the crack to change directions 402. The redirected crack 400 then dispersed in the solder 301.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A solder paste, comprising:
a flux;
a solder powder; and
a metal filler powder, the metal filler powder comprising metal filler particles having melting temperatures greater than a melting temperature of the solder of the solder power, and the metal filler particles having surfaces that are wettable to the solder of the solder powder;
wherein the ratio of the metal filler powder to the total of the metal filler powder and solder powder is such that, after forming a solder joint under reflow soldering at a temperature below the melting temperature of the metal filler particles, a continuous ductile phase of the solder is present in the solder joint and the metal filler particles are present at an intermetallic interface between the solder and a substrate and within a bulk of the solder joint.

2. The solder paste of claim 1, wherein the average size of the metal filler particles is five times or less than the average size of the solder particles.

3. The solder paste of claim 1, wherein the metal filler powder is between 0.5 wt. % and 2.9 wt. % of the total metal load of the solder paste.

4. The solder paste of claim 1, wherein the metal filler particles are sufficiently non-reactive with the solder of the solder powder such that the metal filler particles remain present in the solder joint for an average in-service life of the solder joint.

5. The solder paste of claim 1, wherein the metal filler particles comprise chromium, cobalt, copper, iron, manganese, nickel, zinc, titanium, vanadium, molybdenum, tungsten, Monel alloy, Nichrome, Invar, or bronze particles.

6. The solder paste of claim 5, wherein the metal filler particles further comprise a coating of a metal that is wettable with the solder of the solder powder.

7. The solder paste of claim 6, wherein the coating comprises copper, silver, a solder alloy, tin, nickel, gold, palladium, platinum, titanium, vanadium, molybdenum, tungsten, Monel alloy, Nichrome, Invar, or bronze.

8. The solder paste of claim 6, wherein the metal filler particles comprise copper coated iron particles, silver coated nickel particles, or nickel coated copper particles.

9. The solder paste of claim 6, wherein the metal filler powder is between 0.5 wt. % and 5.0 wt. % of the solder paste.

10. The solder paste of claim 1, wherein the metal filler particles are chemically treated with an oxidation prevention chemical treatment.

11. A method of manufacturing a solder paste, comprising:
mixing a solder powder, a metal filler powder, and a flux to form the solder paste;
the metal filler powder comprising metal filler particles having melting temperatures greater than a melting temperature of the solder of the solder power, and the metal filler particles having surfaces that are wettable to the solder of the solder powder; and
wherein the ratio of the metal filler powder to the total of the metal filler powder and solder powder is such that, after forming a solder joint under reflow soldering at a temperature below the melting temperature of the metal filler particles, a continuous ductile phase of the solder is present in the solder joint and some of the metal filler particles are present at an intermetallic interface between the solder and a substrate and within the bulk of the solder joint.

12. The method of claim 11, wherein the average size of the metal filler particles is five times or less than the average size of the solder particles.

13. The method of claim 11, wherein the metal filler powder is between 0.5 wt. % and 2.9 wt. % of the solder paste.

14. The method of claim 11, wherein the metal filler particles are sufficiently non-reactive with the solder of the solder powder such that the metal filler particles remain present in the solder joint for an average in-service life of the solder joint.

15. The method of claim 11, wherein the metal filler particles comprise chromium, cobalt, copper, iron, manganese, nickel, zinc, titanium, vanadium, molybdenum, tungsten, Monel alloy, Nichrome, Invar, or bronze particles.

16. The method of claim 15, wherein the metal filler particles further comprise a coating of a metal that is wettable with the solder of the solder powder.

17. The method of claim 16, wherein the coating comprises copper, silver, a solder alloy, tin, nickel, gold, palladium, platinum, titanium, vanadium, molybdenum, tungsten, Monel alloy, Nichrome, Invar, or bronze.

18. The method of claim 16, wherein the metal filler particles comprise copper coated iron particles, silver coated nickel particles, or nickel coated copper particles.

19. The method of claim 16, wherein the metal filler powder is between 0.5 wt. % and 5.0 wt. % of the total metal load of the solder paste.

20. The method of claim 11, wherein the metal filler particles are chemically treated with an oxidation prevention chemical treatment.

21. A method of connecting components using solder, comprising:
dispensing a solder paste onto a pad, the solder paste comprising a solder powder, a metal filler powder, and a flux;
placing a component on the dispensed solder paste to create an assembly;
reflow soldering the assembly by heating the assembly to a temperature above a melting temperature of the solder powder and below a melting temperature of the metal filler powder;
cooling the assembly to form a solder joint;
the metal filler powder comprising metal filler particles having melting temperatures greater than a melting temperature of the solder of the solder power, and the metal filler particles having surfaces that are wettable to the solder of the solder powder; and
wherein the ratio of the metal filler powder to the total of the metal filler powder and solder powder is such that a continuous ductile phase of the solder is present in the solder joint and some of the metal filler particles are present at an intermetallic interface between the solder and the component and within a bulk of the solder joint.

22. The method of claim 21, wherein the average size of the metal filler particles is five times or less than the average size of the solder particles.

23. The method of claim 21, wherein the metal filler powder is between 0.5 wt. % and 2.9 wt. % of the solder paste.

24. The method of claim 21, wherein the metal filler particles are sufficiently non-reactive with the solder of the solder powder such that the metal filler particles remain present in the solder joint for an average in-service life of the solder joint.

25. The method of claim 21, wherein the metal filler particles comprise chromium, cobalt, copper, iron, manganese, nickel, zinc, titanium, vanadium, molybdenum, tungsten, Monel alloy, Nichrome, Invar, or bronze particles.

26. The method of claim 25, wherein the metal filler particles further comprise a coating of a metal that is wettable with the solder of the solder powder.

27. The method of claim 26, wherein the coating comprises copper, silver, a solder alloy, tin, nickel, gold, palladium, platinum, titanium, vanadium, molybdenum, tungsten, Monel alloy, Nichrome, Invar, or bronze.

28. The method of claim 26, wherein the metal filler particles comprise copper coated iron particles, silver coated nickel particles, or nickel coated copper particles.

29. The method of claim 26, wherein the metal filler powder is between 0.5 wt. % and 5.0 wt. % of the total metal load of the solder paste.

30. The method of claim 21, wherein the metal filler particles are chemically treated with an oxidation prevention chemical treatment.

31. The solder paste of claim 5, wherein the metal filler particles comprise iron, chromium, tungsten, or alloys thereof.

32. The method of claim 15, wherein the metal filler particles comprise iron, chromium, tungsten, or alloys thereof.
